(19) United States
(12) Patent Application Publication
(10) Pub. No.: US 2026/0145608 A1
(43) Pub. Date: May 28, 2026

(54) RAMP DOOR ASSEMBLY WITH LIFT ASSIST SYSTEM

(71) Applicant: Southland Trailer Corp., Lethbridge (CA)

(72) Inventors: Troy Racz, Lethbridge (CA); Adrian Jones, Lethbridge (CA); Seth Tams, Lethbridge (CA)

(21) Appl. No.: 18/962,095

(22) Filed: Nov. 27, 2024

(51) Int. Cl. B60P 1/43

(52) U.S. Cl. CPC B60P 1/438; B60P 1/435

(57) ABSTRACT

A ramp door assembly coupled to a base is provided. The ramp door assembly has: a ramp door pivotably coupled to the base about a door axis, the ramp door being pivotable between a closed position and an open position; and a lift assist system pivotably coupled to and extending between the ramp door and the base, the lift assist system comprising a spring to generate an assistive torque that biases the ramp door towards the closed position.

### FIELD

The present disclosure generally relates to ramp doors, and more particularly to a ramp door assembly with a lift assist system, and to trailers comprising the same.

### BACKGROUND

United Kingdom Patent No. GB 2393428 to Francis discloses a trailer having a rear wall hinged along its bottom edge to form a fold-down door. When folded downwards, the door doubles as an access ramp into the trailer. The rear door is fitted with a lift-assist mechanism in the form of gas-struts to aid opening and closing of the door.

United Kingdom Patent No. GB 2444049 to Wharton discloses a trailer with a gas spring that damps a drop-leaf when lowering. The gas springs is biased into the extended position and with damping movement function has its piston pivotally mounted at one end on an arm coupled to the drop-leaf and at its other end is pivotally mounted on a side supporting plate.

U.S. Pat. No. 4,647,270 to Maloney discloses a transporting unit including a horizontal section which is mounted to a truck and functions as the bed for the truck. A beaver tail section extends downwardly from the horizontal section and a foldable ramp section is hinged to the beaver tail section. A hydraulic piston cylinder mechanism is connected to a support and to an extension from the beaver tail section.

U.S. Pat. No. 5,096,362 to Best discloses a ramp attached to and used for the loading and unloading of goods from a vehicle, typically a truck. When not in use, the ramp folds compactly and is latched in an upright position at the rear of the vehicle. The ramp may be unfolded and extended in order to transport goods to and from the vehicle. The ramp includes one or more spring cylinders for damping the movement of ramp as it is being raised or lowered. The cylinders may be pivotally attached using fasteners to plates, which plates are rigidly attached to mounts. Spring cylinders also are rigidly connected to plates, which plates are fixedly attached, by welding or other appropriate means, to first ramp segment.

U.S. Pat. No. 8,782,840 to Saucier discloses a ramp assembly includes a frame assembly, a ramp connected to the frame assembly, a drive member having first and second engagements, and a counterbalance mechanism cooperating with the drive member. The ramp is pivotable relative to the frame assembly and has a deployed position and a stowed position. The drive member is configured to move the ramp between the deployed position and the stowed position. The counterbalance mechanism includes a gas strut having a first end and a second end. The first end of the gas strut is secured to the frame assembly and the second end of the gas strut is movable relative to the frame assembly. The first and second engagements of the drive member are configured to engage the second end of the gas strut.

U.S. Pat. No. 9,676,428 to Jorgensen discloses a winch-controlled storage door with spring-damper systems, and other means of controlling the speed with which a door opens or the extent to which assistance is provided the user when closing the door. The storage door may include one or more dampers disposed between the door and the trailer overhang. The dampers are fluid (i.e., gas, liquid, etc.) dampers that resist free motion of the door when lowering or otherwise extending. This allows controlled deployment of the door. Alternatively, the dampers may comprise fluid spring cylinder dampers, which include a fluid damper and a spring element. The fluid (i.e., gas, liquid, etc.) resists motion (i.e. dampens) the storage door while deploying, and the springs are used to assist stowing the door against the overhang (i.e. returning the door to a closed position). The fluid dampers may be such that they resist in one direction (i.e. during extension/rebound), and do not resist when closing the doors (i.e. during compression). The springs may be disposed within the dampers, and are extended when the door is deployed. In this way, the doors apply a return force on the door such that the force necessary to close the door is reduced for the user.

### SUMMARY

It should be appreciated that this summary is provided to introduce a selection of concepts that are further described below in the detailed description of embodiments. This summary is not intended to be used to limit the scope of the claimed subject matter.

Accordingly, in an aspect, there is provided a ramp door assembly coupled to a base, the ramp door assembly comprising: a ramp door pivotably coupled to the base about a door axis, the ramp door being pivotable between a closed position and an open position; and a lift assist system pivotably coupled to and extending between the ramp door and the base, the lift assist system comprising a spring to generate an assistive torque that biases the ramp door towards the closed position.

In one or more embodiments, the lift assist system may be pivotably coupled to the ramp door at a door mounting point and may be pivotably coupled to the base at a base mounting point.

In some of the above embodiments, a vertical plane may be defined through the door axis, an undersurface of the base may define a horizontal plane, and the base mounting point may be vertically located at or below the horizontal plane and may be horizontally located apart from the vertical plane in a direction that the ramp door opens.

In some of the above embodiments, the base mounting point and the door mounting point may be located, and the lift assist system may be sized, such that the assistive torque generated by the lift assist system keeps the apparent weight of the ramp door at a lifting point from exceeding a maximum of 50 lbs as the ramp door pivots from the open position to the closed position.

In some of the above embodiments, the ramp door assembly may comprise a plurality of the lift assist systems, and the assistive torque may be a sum of the assistive torques generated by the plurality of the lift assist systems.

In one or more embodiments, the ramp door assembly may further comprise a door mount and a base mount, the lift assist system may be pivotably coupled to the ramp door via the door mount, and the lift assist system may be pivotably coupled to the base via the base mount.

In some of the above embodiments, the base mount may be fixedly coupled to at least two non-parallel surfaces of the base.

In some of the above embodiments, the base mount may comprise a pair of flanges and a base portion that define a U-shape, and an end of the lift assist system may be pivotably coupled to and received between the pair of flanges.

In one or more embodiments, the ramp door assembly may further comprise one or more hinges pivotably coupling the ramp door to the base.

In one or more embodiments, the spring may be a pneumatic cylinder that acts as a gas spring to generate the assistive torque.

According to another aspect, there is provided a trailer comprising: a base frame for coupling to a vehicle; a plurality of wheels pivotably coupled to the base frame, the wheels engaging a ground surface to support the base frame; and a ramp door assembly coupled to the base frame, the ramp door assembly comprising: a ramp door pivotably coupled to the base frame about a door axis, the ramp door being pivotable between a closed position and an open position; and a lift assist system pivotably coupled to and extending between the ramp door and the base frame, the lift assist system comprising a spring to generate an assistive torque that biases the ramp door towards the closed position.

In one or more embodiments, the lift assist system is pivotably coupled to the ramp door at a door mounting point and is pivotably coupled to the base frame at a base mounting point.

In some of the above embodiments, a vertical plane may be defined through the door axis, an undersurface of the base frame may define a horizontal plane, and the base mounting point may be vertically located at or below the horizontal plane and may be horizontally located apart from the vertical plane in a direction that the ramp door opens.

In some of the above embodiments, the base mounting point and the door mounting point may be located, and the lift assist system may be sized, such that the assistive torque generated by the lift assist system keeps the apparent weight of the ramp door at a lifting point from exceeding a maximum of 50 lbs as the ramp door pivots from the open position to the closed position.

In some of the above embodiments, the ramp door assembly may comprise a plurality of the lift assist systems, and the assistive torque may be a sum of the assistive torques generated by the plurality of the lift assist systems.

In one or more embodiments, the ramp door assembly may further comprise a door mount and a base mount, the lift assist system may be pivotably coupled to the ramp door via the door mount, and the lift assist system may be pivotably coupled to the base frame via the base mount.

In some of the above embodiments, the base mount may be fixedly coupled to at least two non-parallel surfaces of the base.

In some of the above embodiments, the base mount may comprise a pair of flanges and a base portion that define a U-shape, and an end of the lift assist system may be pivotably coupled to and received between the pair of flanges.

In one or more of the above embodiments, the ramp door assembly may further comprise one or more hinges pivotably coupling the ramp door to the base frame.

In one or more of the above embodiments, the spring may be a pneumatic cylinder that acts as a gas spring to generate the assistive torque.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is an isometric view of a trailer that includes a ramp door with a lift assist system, a rear of the trailer is shown with the ramp door in a closed position;

FIG. 2 is a right side view of the trailer of FIG. 1, with the ramp door in an open position;

FIG. 3 is an enlarged rear partial view of the trailer of FIG. 1, with the ramp door in the closed position;

FIG. 4 is an enlarged right side partial view of the trailer of FIG. 1, showing the lift assist system with the ramp door in the closed position;

FIG. 5 is an enlarged right side partial view of the trailer of FIG. 1, showing the lift assist system with the ramp door in the open position;

FIG. 6 is an enlarged axonometric partial view of the trailer of FIG. 1, showing an underside of the lift assist system when fully compressed with the ramp door in the open position;

FIG. 7 is an enlarged axonometric partial view of the trailer of FIG. 1, showing the lift assist system when fully extended with the ramp door in the closed position;

FIG. 8 is an isometric view of another embodiment of a trailer, which includes a plurality of ramp doors and a plurality of lift assists systems;

FIG. 9 is an isometric view of the trailer of FIG. 8, with each of the ramp doors in a respective open position;

FIG. 10 is a rear view of the trailer of FIG. 8;

FIG. 11 is a right side view of the trailer of FIG. 8, with each of the ramp doors in a respective closed position;

FIG. 12 is a right side view of the trailer of FIG. 8, with each of the ramp doors in the respective open position;

FIG. 13 is an enlarged right side partial view of the trailer of FIG. 8, showing one of the lift assist systems when fully extended with a rear of the ramp doors in the closed position;

FIG. 14 is an enlarged right side partial view of the trailer of FIG. 8, showing the one of the lift assist systems when fully compressed with the rear of the ramp doors in the closed position;

FIG. 15 is an isometric view of another embodiment of a trailer, which includes a ramp door and a pair of lift assist systems;

FIG. 16 is a rear view of the trailer of FIG. 15;

FIG. 17 is a right side view of the trailer of FIG. 15, with the ramp door in a closed position;

FIG. 18 is a right side view of the trailer of FIG. 15, with the ramp door in an open position;

FIG. 19 is an enlarged right side partial view of the trailer of FIG. 15, showing one of the lift assist systems when fully extended with the ramp door in the closed position; and

FIG. 20 is an enlarged right side partial view of the trailer of FIG. 15, showing the one of the lift assist systems when fully compressed with the ramp door in the open position.

### DETAILED DESCRIPTION OF EMBODIMENTS

Illustrative embodiments of the invention are described below. The following explanation provides specific details for a thorough understanding of and enabling description for these embodiments. One skilled in the art will understand that the invention may be practiced without necessarily including all of the details described below. In some instances, well-known structures and functions have not been shown or described in detail to avoid unnecessarily obscuring the description of the embodiments.

Unless the context clearly requires otherwise, throughout the description and the claims, the words “comprise,” “comprising,” “includes,” “including,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below”, and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list. When the word “each” is used to refer to an element that was previously introduced as being at least one in number, the word “each” does not necessarily imply a plurality of the elements, but can also mean a singular element.

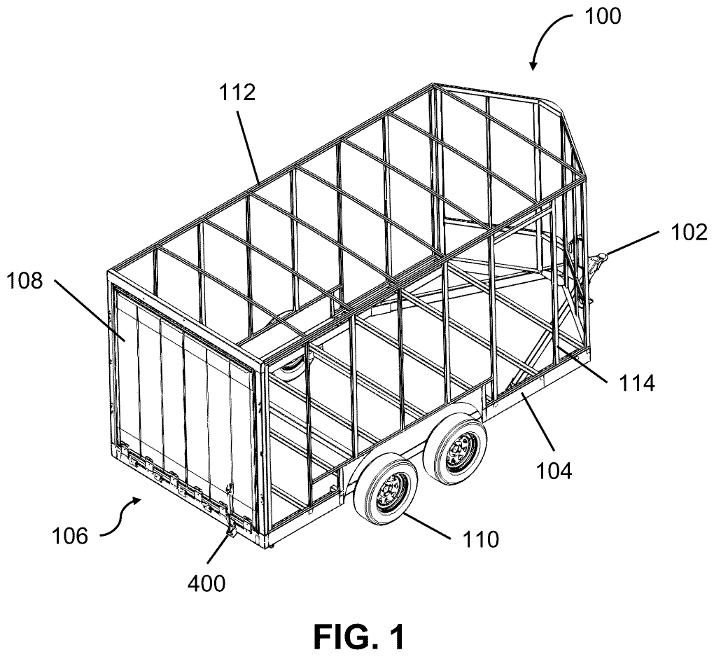

Turning to FIGS. 1 to 3, a trailer is shown and generally identified by reference character 100. The trailer 100 may be used to haul a load, such as livestock, equipment, etc. As will be appreciated, the trailer 100 may include one or more floor, wall, and/or roof panels, as is known in the art. Such panels have been omitted in these figures to avoid obstructing the elements described below.

The trailer 100 may have a hitch receiver 102 for receiving a hitch (not shown) from a vehicle (not shown). The trailer 100 may have a base frame 104 coupled to two or more wheels 110. The base frame 104 may be configured to transfer towing forces through the trailer 100, such as from the hitch receiver 102 to the wheels 110 or vice versa. A jack 202 may be present near the hitch receiver 102 to hold the trailer 100 level when the trailer 100 is not hitched to the vehicle.

The trailer 100 may have an upper frame 112 coupled to the base frame 104 that may or may not be enclosed with metal panels or canvas. The upper frame 112 may comprise one or more vertical ribs 114 to provide structural strength to the trailer 100.

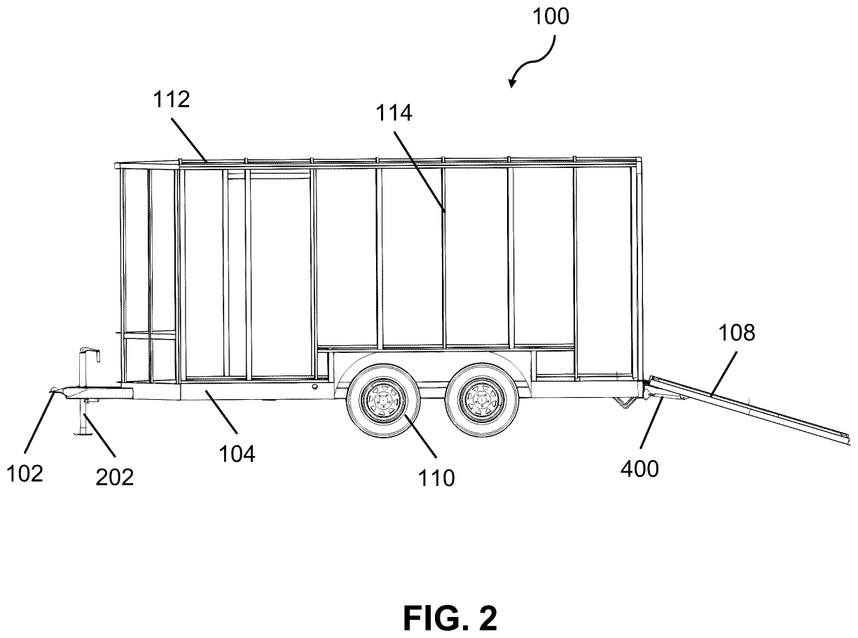

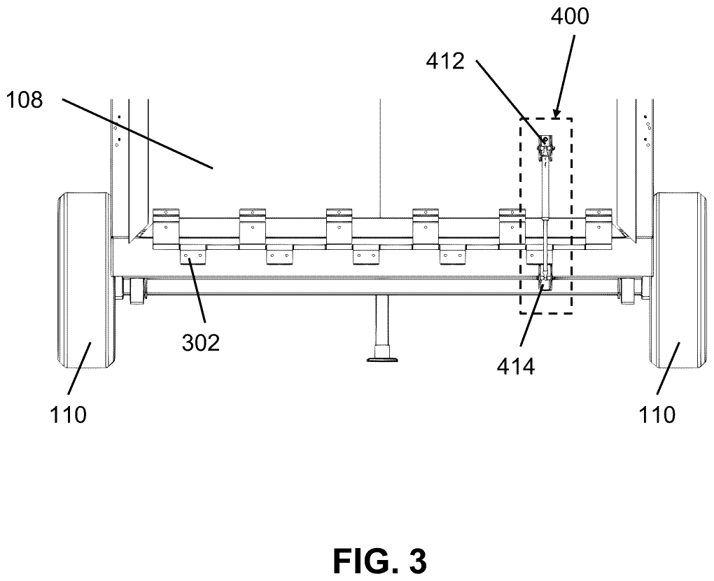

At a rear 106 of the trailer 100 may be a ramp door 108. As shown in FIG. 1, the ramp door 108 is in a closed position and the ramp door 108 may abut or be received by the upper frame 112. As shown in FIG. 2, the ramp door 108 may swing down and away from the upper frame 112 to rest on the ground behind the trailer 100. As shown particularly in FIG. 3, the ramp door 108 may be coupled to the base frame 104 at the rear 106 of the trailer 100 by a plurality of hinges 302.

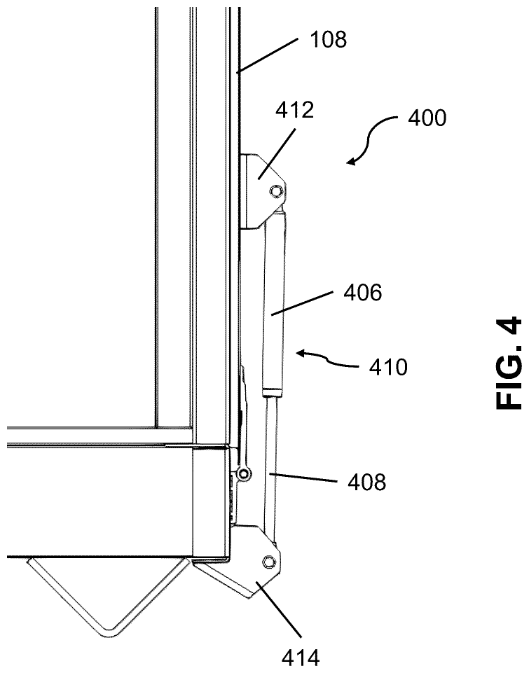

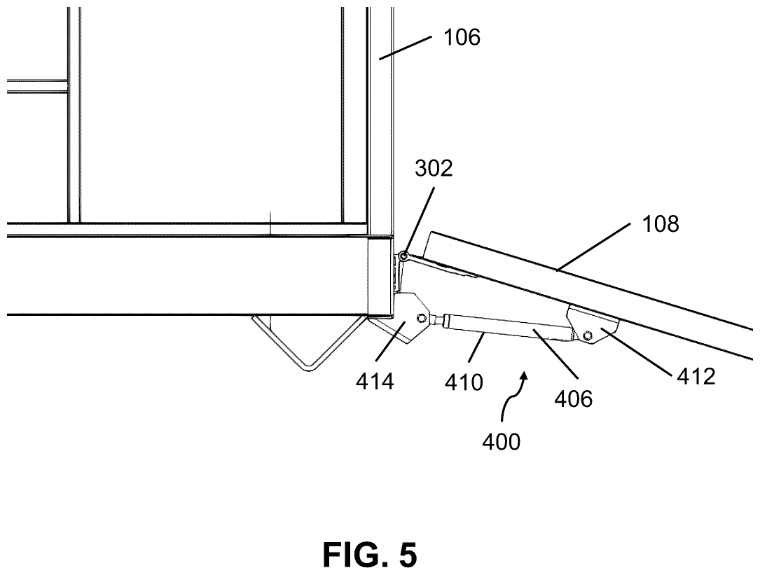

Turning particularly to FIGS. 4 to 7, a lift assist system 400 may be pivotably coupled between the ramp door 108 and the base frame 104 at the rear 106 of the trailer 100. In this aspect, the lift assist system 400 comprises a pneumatic cylinder 410 having a piston rod 408 travelling within a barrel 406. The barrel 406 of the pneumatic cylinder 410 may be pivotably coupled to the ramp door 108 by a barrel bracket 412 (e.g. an upper or door mount). The barrel bracket 412 may be bolted using one or more bolts through the ramp door 108. The barrel bracket 412 may be a U-bracket oriented to receive the barrel 406 between a pair of flanges of the barrel bracket 412. The barrel bracket 412 may be bolted to the ramp door 108 at a position to ensure suitable geometry for the lift assist system 400 for different sizes of ramp doors 108.

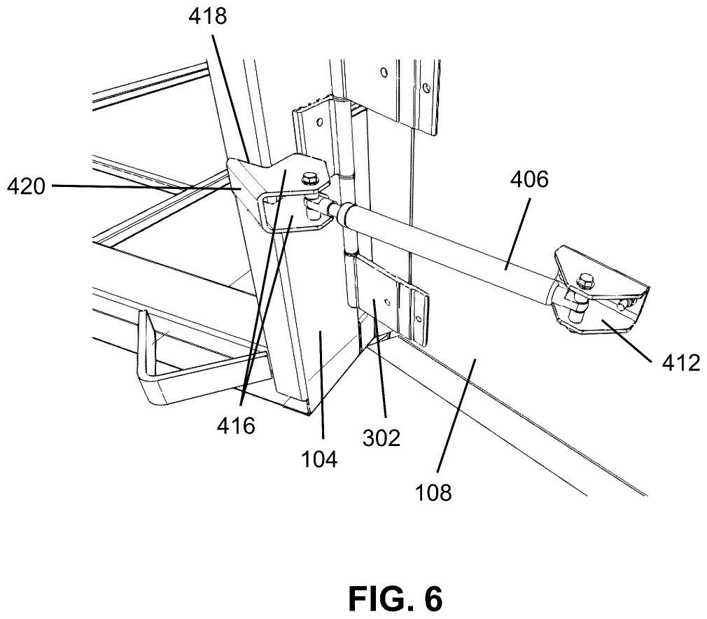

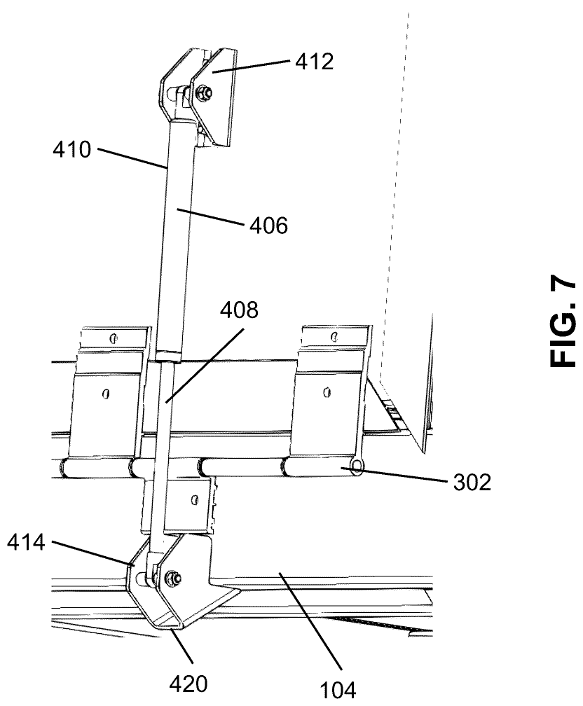

Shown particularly in FIGS. 6 and 7, the piston rod 408 of the pneumatic cylinder 410 may be pivotably coupled to the base frame 104 by a piston mount 414 (e.g. a lower or base mount). The piston mount 414 may comprise a U-shape for receiving the piston rod 408 between a pair of flanges 416. A closed end (base of the U-shape) 420 of the piston mount 414 may connect the pair of flanges 416. The piston rod 408 may be pivotably coupled at an open end of the U-shape. The pair of flanges 416 may be shaped on one end 418 to correspond to a shape of the base frame 104. The piston mount 414 may be formed of hollow structural sections (HSS) with the pair of flanges 416 cut using tube-laser technology to precisely match the shape of the base frame 104. In this manner, the pair of flanges 416 may be welded to the base frame 104 to provide structural strength between the pair of flanges 416.

The pneumatic cylinder 410 may act as a gas spring that applies increasing force on the ramp door 102 as the ramp door 102 lowers, creating an optimized lift assistance force curve as the door ramp 102 is raised from an open position to a closed position. A gas spring friction damping may allow the ramp door 102 to come down slowly and predictably, even when let go of completely.

As shown herein, when the ramp door 102 is in the closed position, the pneumatic cylinder 410 may be fully extended. Conversely, when the ramp door 102 is in an open position, the pneumatic cylinder may be fully compressed.

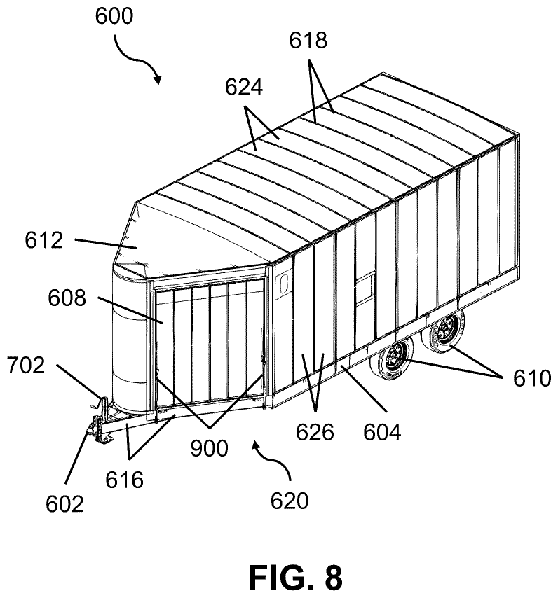

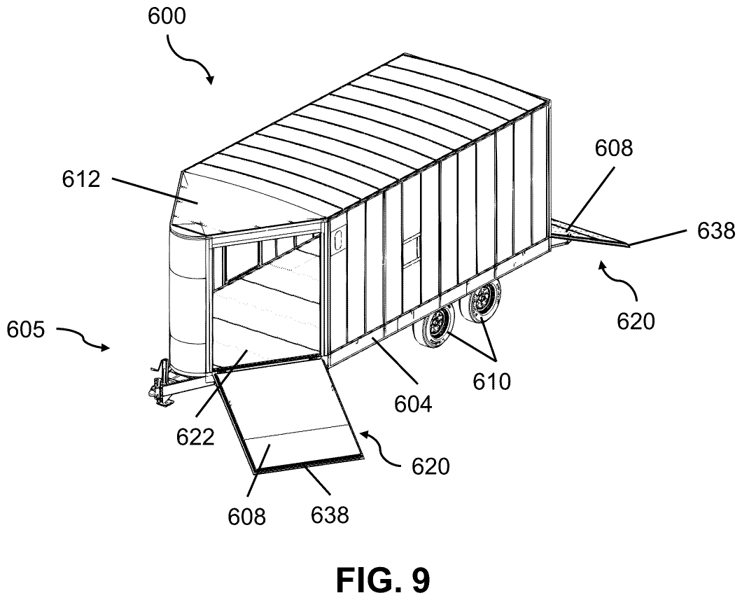

Turning to FIG. 8 to 14, another embodiment of a trailer is shown and generally identified by reference character 600. The trailer 600 is similar to the trailer 100 and like elements are denoted by like reference characters incremented by 500.

The trailer 600 is configured to be towed behind a vehicle (not shown) and can be used to haul a load, such as livestock, equipment, etc. The trailer 600 includes a plurality of wheels 610, a base frame 604, and a plurality of ramp door assemblies 620. In the subject embodiment, the trailer 600 comprises two of the ramp door assemblies 620, one near the front of the trailer 600 and one at the rear of the trailer 600. The ramp door assemblies 620 are substantially the same. Each of the ramp door assemblies 620 comprises a ramp door 608, a plurality of hinges 802, and a pair of lift assist systems 900. The trailer 600 may further include a hitch receiver 602, an upper frame 612, and a jack 702.

The wheels 610 engage a ground surface and support the base frame 604. The wheels 610 are pivotably coupled to the base frame 604, such as by a conventional suspension system as is known in the art. The wheels 610 transfer weight from the base frame 604 to the ground. This weight can include a weight of the trailer and a weight of the load, or at least a portion thereof.

The base frame 604 is configured to support the load during towing and to transfer towing forces through the trailer 600. The base frame 604 includes a plurality of base frame members 616 that are coupled together to distribute the weight of the load and to transfer towing forces. In the subject embodiment, the base frame members 616 comprise a plurality of beams, such as metal beams, that are joined together by welding, fastening, or the like. In other embodiments, the base frame members 616 may comprise other suitable elements that are coupled together, such as hollow structural sections (HSS), composite panels, metal plates, or the like. In some embodiments, the base frame 604 may comprise a single unitary body.

The base frame 604 includes a plurality of floor panels 626. The floor panels 626 facilitate supporting the load. For example, the floor panels 626 can help to distribute the weight of the load, and can help to provide a uniform surface for the load to be rested on. The floor panels 626 are coupled to the base frame members 616, such as by welding, fasteners, or the like. In other embodiments, the floor panels 626 may be integrally formed with the base frame members 616.

The base frame 604 is configured to be coupled to a vehicle (not shown) for towing. Accordingly, the base frame 604 includes a coupler near a front 605 of the trailer 600 for coupling the trailer 600 to the vehicle. In the subject embodiment, the coupler is a hitch receiver 602. In other embodiments, the coupler may be a fifth wheel coupling, or other suitable coupler as is known in the art.

The hitch receiver 602 is configured to receive a hitch (not shown) of the vehicle, as is known in the art, to couple the trailer 600 to the vehicle. When the trailer 600 is coupled to the vehicle, towing forces can be transferred from the vehicle to the trailer 600 (or vise versa) via the hitch and the hitch receiver 602. Such towing forces can then be transferred through the trailer 600 by the base frame 604, such as from the hitch receiver 602 to the wheels 610 (or vice versa).

The jack 702 may be present near the front of the trailer 600. The jack 702 is configured to hold the trailer 600 level, when the trailer 600 is not coupled to a vehicle. When the trailer 600 is not coupled to the vehicle, the jack 702 rests on the ground and supports the front 605 of the trailer 600. The jack 702 may be adjustable in height to help hold the trailer 600 level.

The upper frame 612 may be coupled to and supported by the base frame 604 of the trailer 600. The upper frame 612 comprises a plurality of upper frame members 618 that are coupled together and to the base frame 604 to provide structural strength to the trailer 600. The upper frame members 618 may include vertical ribs, horizontal ribs, or other suitable members, and may be joined by welding, fastening, or the like. In the subject embodiment, the upper frame members 618 comprise a plurality of metal beams. In other embodiments, the upper frame members 618 may comprise hollow structural sections (HSS), composite panels, metal plates, or the like. In some embodiment, the upper frame 612 may comprise a single unitary body. The upper frame 612 includes a plurality of panels to enclose at least a portion of the trailer 600. In the subject embodiment, the panels include roof panels 624 and wall panels 626, which form a roof and walls of the trailer 600, respectively. The panels 624, 626 are coupled to the upper frame members 618, such as by welding, fasteners, or the like. In other embodiments, the panels 624, 626 may be integrally formed with the upper frame members 618. As will be appreciated, in some embodiments the upper frame 612 may be omitted entirely, such as where the trailer 600 is a flat deck trailer or a flatbed trailer.

As discussed above, the trailer 600 includes two of the ramp door assemblies 620. One of the ramp door assemblies 620 is located near the front of the trailer 600, and the other of the ramp door assemblies 620 is located at the rear of the trailer 600. The ramp door assemblies 620 are substantially the same. Accordingly, only one of the ramp door assemblies 620 is described below for brevity.

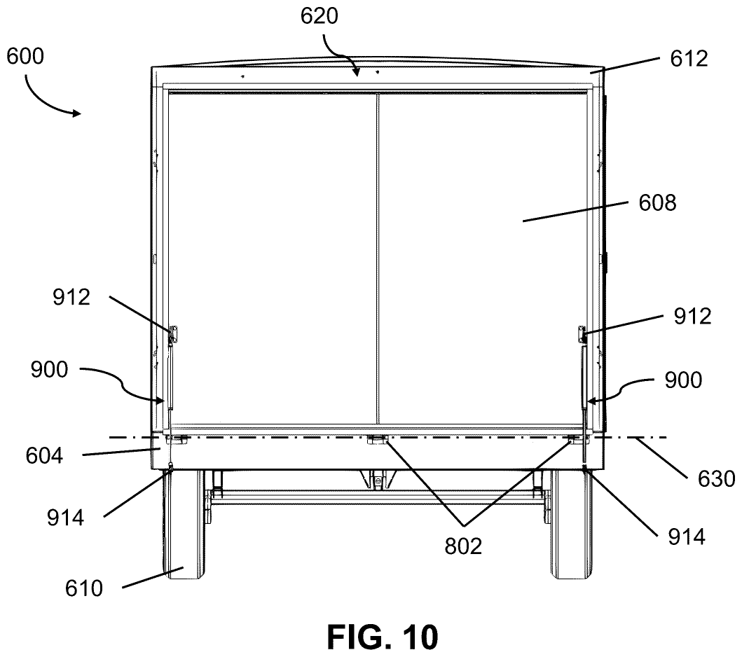

The ramp door assembly 620 is coupled to the base frame 604. As shown in FIG. 10, the ramp door assembly 620 includes a ramp door 608, a plurality of hinges 802, and a pair of lift assist systems 900. The ramp door assembly 620 further includes a door mount 912 and a base mount 914 for each of the lift assist systems 900. Accordingly, in the subject embodiment, the ramp door assembly 620 includes two door mounts 912 and two base mounts 914.

The ramp door 608 is pivotably coupled to base frame 604. In the subject embodiments, the ramp door 608 is pivotably coupled to the base frame 604 via the plurality of hinges 802. However, in other embodiments, the ramp door 608 may be directly pivotably coupled to the base frame 604. For example, the ramp door 608 and/or the base frame 604 may include hinges that are integrally formed therewith.

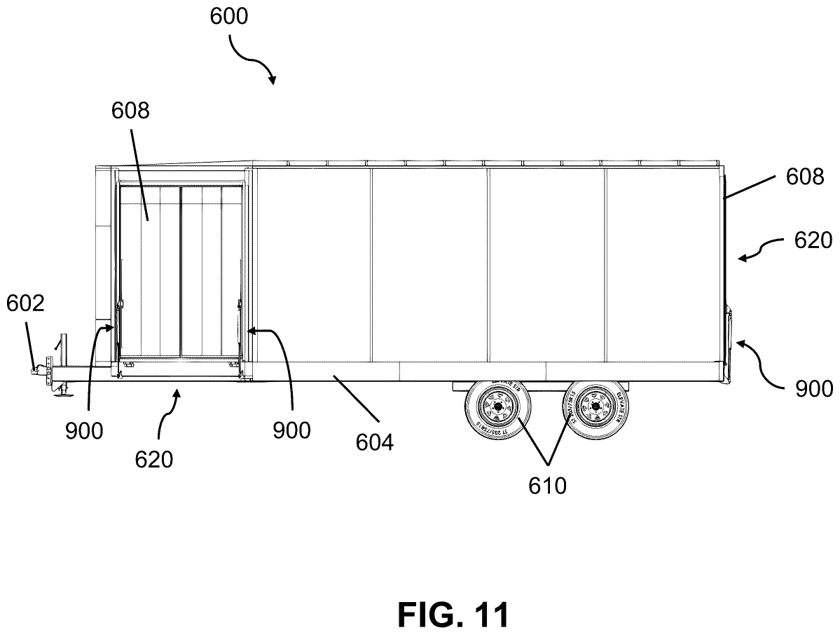

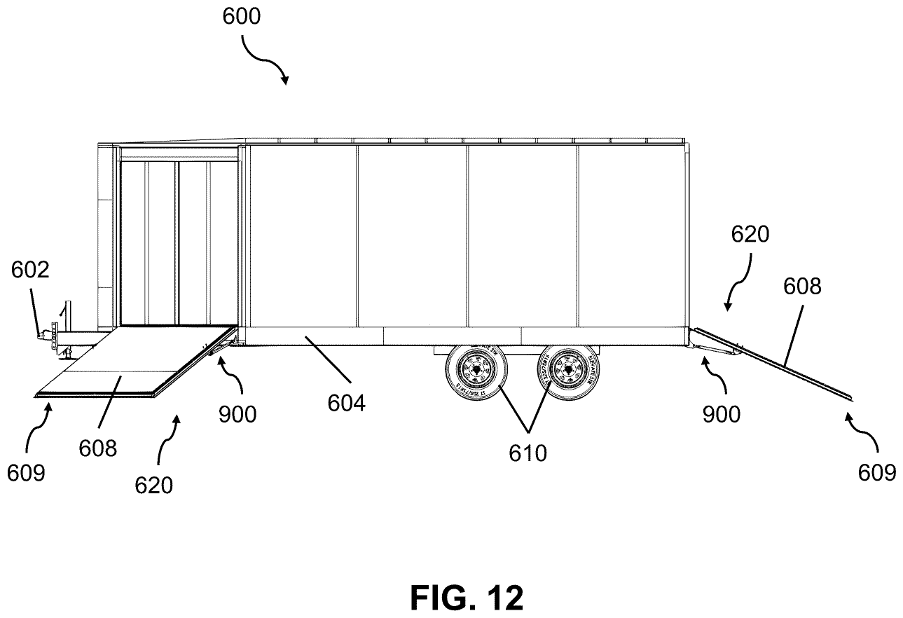

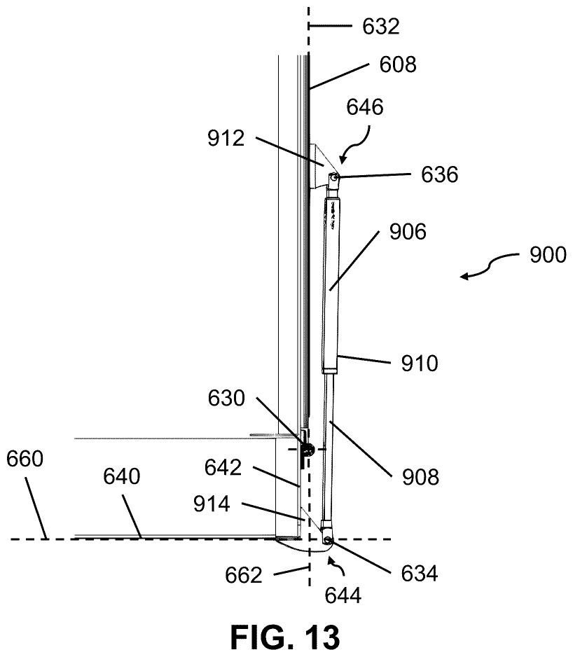

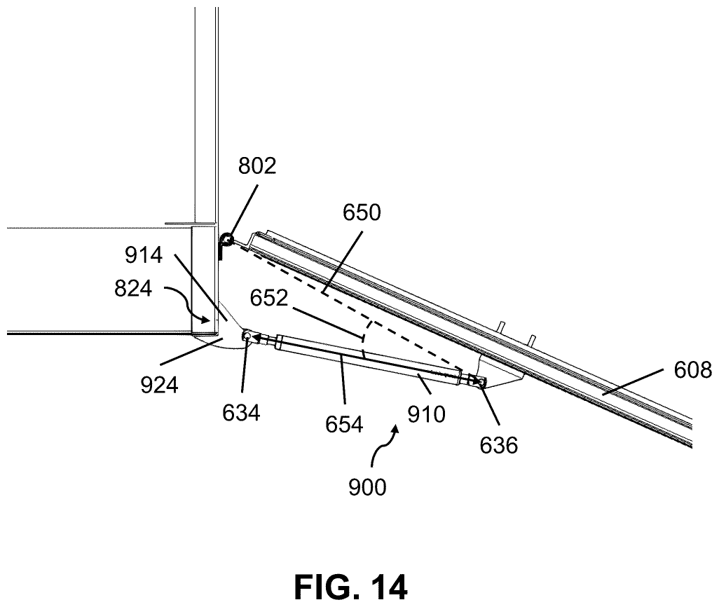

The ramp door 608 is pivotable about a door axis 630. In the subject embodiment, the door axis 630 is defined by the hinges 802. The ramp door 608 is pivotable between a closed position (FIGS. 11 and 13) and an open position (FIGS. 12 and 14). As shown in FIG. 13, the ramp door 608 defines a door plane 632 in the closed position. The door plane 632 is a generally vertical plane. In some embodiments, the door plane 632 may be slightly tilted from vertical, such that a weight of the ramp door 608 in the closed position will tend to hold the ramp door 608 closed.

As discussed above, the ramp door assembly 620 includes a pair of lift assist systems 900. One of the lift assist systems 900 is located near a right side of the ramp door 608, and the other of the lift assist systems 900 is located near a left side of the ramp door 608. The lift assist systems 900 are substantially the same. For example, the lift assist systems 900 may be identical, or mirror images of each other. Accordingly, only one of the lift assist systems 900 is described below for brevity.

The lift assist system 900 is pivotably coupled to and extends between the base frame 604 and the ramp door 608. As shown in FIGS. 13 and 14, the lift assist system 900 is pivotably coupled to the base frame 604 at a base mounting point 634, and the lift assist system 900 is pivotably coupled to the ramp door 608 at a door mounting point 636. In the subject embodiment, a base end 644 of the lift assist system 900 is pivotably coupled to the base frame 604 via the base mount 914, and a door end 646 of the lift assist system 900 is pivotably coupled to the ramp door 608 via the door mount 912. However, in other embodiments, the lift assist system 900 may be directly pivotably coupled to the base frame 604 and/or the ramp door 608. In such embodiments, the base frame 604 and/or the ramp door 608 may include integrally formed mounts for pivotably coupling to the lift assist system 900.

The door mount 912 comprises a generally L-shaped plate that is fixedly coupled to the ramp door 608 at a proximal end, and is pivotably coupled to the lift assist system 900 at a distal end. The base mount 914 comprises a generally fin-shaped body 924. The body 924 is fixedly coupled at a proximal end 824 to at least two non-parallel surfaces of the base frame 604, and is pivotably coupled to the lift assist system 900 at a distal end of the body 924. In the subject embodiment, the proximal end 824 of the base mount 914 is fixedly coupled to an undersurface 640 and to an outward-facing surface 642 of the base frame 604. The proximal end 824 of the base mount 914 is laser cut to precisely match the shape of the base frame 604 (e.g. to precisely match the at least two non-parallel surfaces). The mounts 912, 914 can be fixedly coupled by fasteners, welding, or the like. The mounts 912, 914 can be pivotably coupled to the lift assist system 900 by clevis joints, or the like.

The lift assist system 900 biases the ramp door 608 towards the closed position by generating an assistive torque on the ramp door 608. The assistive torque is described in greater detail below. The lift assist system 900 comprises a spring to bias the ramp door towards the closed position. In the subject embodiment, the spring is a pneumatic cylinder 910 that acts as a gas spring. The pneumatic cylinder 910 includes a piston rod 908 and a barrel 906. The piston rod 908 travels within the barrel 906 as the pneumatic cylinder 910 is extended and compressed. As will be appreciated, an outward force generated by the pneumatic cylinder 910 increases as the pneumatic cylinder 910 is compressed. As shown in FIG. 13, the pneumatic cylinder 910 is fully extended when the ramp door 608 is in the closed position. Accordingly, the outward force generated by the pneumatic cylinder 910 is at or near zero when the ramp door 608 is in the closed position, which can allow the pneumatic cylinder 910 to be easily installed when the ramp door 608 is closed. As shown in FIG. 14, the pneumatic cylinder 910 is fully compressed when the ramp door 608 is in the open position. Thus, the outward force generated by the pneumatic cylinder 910 increases as the ramp door 608 is opened. The pneumatic cylinder 910 also provides friction damping that may allow the ramp door 608 to come down slowly and predictably, even when let go completely.

During operation, a user can rotate the ramp door 608 from the open position towards the closed position by generating a manual torque on the ramp door 608. The manual torque can be generated by the user exerting a manual force on the ramp door 608, such as by pulling up on the ramp door 608. The manual force the user is required to exert on the ramp door 608 to rotate the ramp door 608 towards the closed position is defined as the “apparent weight” of the ramp door 608. As will be appreciated, the apparent weight of the ramp door 608 will depend on a lifting point where the user exerts the manual force on the ramp door 608. It is generally preferably to locate the lifting point as far from the door axis 630 as possible, to minimize the apparent weight of the ramp door 608. Accordingly, in the subject embodiments, the lifting point 638 is located at a free end 609 of the ramp door 608, opposite the door axis 630. In other embodiments, the lifting point 638 may be located at a handle for lifting the ramp door 608. One skilled in the art will understand that the lifting point is defined as the furthest point from the door axis where a user would reasonably be expected to lift the ramp door.

The apparent weight of the ramp door 608 may vary as the ramp door 608 pivots from the open position to the closed position; this is because the required manual torque that the user must generate to rotate the ramp door 608 towards the closed position may vary as the ramp door 608 pivots. As will be appreciated, to rotate the ramp door 608 towards the closed position, the sum of the manual torque generated by the user and the complementary assistive torques generated by the lift assist systems 900 must exceed the gravitational torque biasing the ramp door 608 towards the open position. Accordingly, if the gravitational torque on the ramp door 608 increases or decreases and the assistive torques generated by the lift assist systems 900 do not increases or decrease by an equivalent amount, the required manual torque that the user must generate will change and, thus, the apparent weight of the ramp door 608 will vary.

As will be appreciated, the gravitation torque on the ramp door 608 increases as the force of gravity on the ramp door 608 approaches perpendicular with a moment arm defined from the door axis 630 to a center of mass of the ramp door 608. Accordingly, in the subject embodiment, the gravitational torque on the ramp door 608 is at a maximum when the ramp door 608 is horizontal. Therefore, if there was no assistive torque, the required manual torque that the user would need to generate to rotate the ramp door 608 towards the closed position (and thus the apparent weight of the ramp door 608) would increase as the ramp door 608 pivots from the open position to horizontal, would reach a maximum when the ramp door 608 is horizontal, and would decreases as the ramp door 608 pivots from horizontal to the closed position.

However, in the subject embodiment, the lift assist systems 900 generate the assistive torques to bias the ramp door 608 towards the closed position. These assistive torques complement the manual torque generated by the user, and thereby decrease the required manual torque that the user must generate to rotate the ramp door 608 towards the closed position. Accordingly, the apparent weight of the ramp door 608 decreases as the assistive torques generated by the lift assist systems 900 increase.

The assistive torque generated by each lift assist system 900 will depend on an assistive force generated by the lift assist system 900 (e.g., the outward force generated by the pneumatic cylinder 910) and an angle between the assistive force and a corresponding moment arm 650 (i.e., the moment arm 650 defined from the door axis 630 to the door mounting point 636 for the respective lift assist system 900). As shown in FIG. 14, the angle 652 between the assistive force 654 generated by the lift assist system 900 and the moment arm 650 is determined by the relative locations of the base mounting point 634, the door mounting point 636, and the door axis 630. Thus, by altering the locations of the base mounting point 634 and the door mounting point 636 relative to the door axis 630, it may be possible to increase the assistive torque generated by the lift assist system 900 for a fixed assistive force, and thereby decrease the apparent weight of the ramp door 608 without increasing a power of the lift assist system 900.

Further to the above, the assistive torque generated by each lift assist system 900 will generally increase as the base mounting point 634 moves farther away from the door axis 630 both horizontally and vertically (due to the increase in angle 652 between the assistive force and the moment arm 650). Similarly, the magnitude of the assistive torque generated by the lift assist system 900 will generally increase as the door mounting point 636 moves farther away from the door axis 630 in a direction up the ramp door 608 (due to the increase in a length of the moment arm 650). Accordingly, by locating at least one of the base mounting point 634 and the door mounting point 636 further from the door axis 630 as described above, it may be possible to increase the assistive torque generated by the lift assist system 900 without increasing the assistive force thereof (i.e. without increasing the power, and hence the weight and the cost, of the lift assist system 900).

As shown for the subject embodiment in FIG. 13, the base mounting point 634 is vertically located at or below a horizontal plane 660 defined by an undersurface 640 of the base frame 604, and is horizontally located apart from a vertical plane 662 in a direction that the ramp door 608 opens (e.g. in a rearward direction, for FIG. 13). The vertical plane 662 being defined through the door axis 630. Accordingly, in the subject embodiment, the lift assist system 900 will tend to generate more assistive torque than a similar lift assist system where the base mounting point is vertically located above the horizontal plane 660.

It is generally desirably to increase the assistive torques generated by each lift assist system 900, to minimize the apparent weight of the ramp door 608. However, if the sum of the assistive torques generated by the lift assist systems 900 match or exceed the gravitational torque on the ramp door 608, the ramp door 608 may tend to float in the air or shut itself—either of which can be problematic. Accordingly, it is generally preferable to size and locate the lift assist systems 900 such that the sum of the assistive torques they generate in the open position is slightly less than the gravitational torque on the ramp door 608 in the open position. In this way, once the ramp door 608 is opened, the ramp door 608 will tend to remain in the open position, and the apparent weight of the ramp door 608 in the open position will be relatively low. It is also generally preferably to size and locate the lift assist systems 900 such that the sum of the assistive torques they generate keeps the apparent weight of the ramp door 608 at the lifting point 638 from exceeding a maximum threshold as the ramp door 608 pivots from the open position to the closed position. The maximum threshold is preferable a maximum of 50 lbs, and more preferably a maximum of 30 lbs. This can enable the user to operate the ramp door 608 without assistance and/or with limited risk of injury.

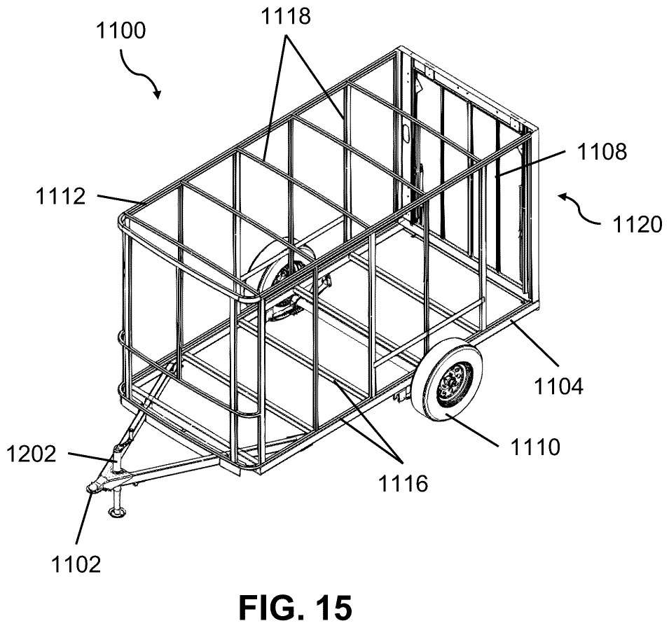

Turning to FIGS. 15 to 20, another embodiment of a trailer is shown and generally identified by reference character 1100. The trailer 1100 is similar to the trailer 600 and like elements are denoted by like reference characters incremented by 500. As will be appreciated, the trailer 1100 may include one or more floor, wall, roof, and/or door panels, as is known in the art. Such panels have been omitted in these figures to avoid obstructing the elements described below.

The trailer 1100 is configured to be towed behind a vehicle (not shown) and can be used to haul a load, such as livestock, equipment, etc. The trailer 1100 includes a base frame 1104, a plurality of wheels 1110, and a ramp door assembly 1120. The ramp door assembly 1120 includes a ramp door 1108, a plurality of hinges 1302, and a pair of lift assist systems 1400. The trailer 1100 may further include a hitch receiver 1102, an upper frame 1112, and a jack 1202.

The wheels 1110 engage a ground surface and support the base frame 1104 thereon. The wheels 1110 are pivotably coupled to the base frame 1104, such as by a conventional suspension system as is known in the art. The wheels 1110 transfer weight from the base frame 1104 to the ground. This weight can include a weight of the trailer and a weight of the load, or at least a portion thereof.

The base frame 1104 is configured to support the load during towing and to transfer towing forces through the trailer 1100. The base frame 1104 includes a plurality of base frame members 1116 that are coupled together to distribute the weight of the load and to transfer towing forces. In the subject embodiments, the base frame members 1116 comprise a plurality of beams, such as metal beams, that are joined by welding, fasteners, or the like. In other embodiments, the base frame members 1116 may comprise other suitable elements that are coupled together, such as hollow structural sections (HSS), composite panels, metal plates, or the like. In some embodiments, the base frame 1104 may comprise a single unitary body. As will be appreciated, the base frame 1104 may include one or more floor panels to facilitate supporting the load, such as the floor panels described above. The floor panel(s) may be integrally formed as part of the base frame 1104, or may be coupled to other elements of the base frame 1104 (such as to the base frame members 1116 by welding, fastening, or the like).

The base frame 1104 is configured to be coupled to a vehicle (not shown) for towing. Accordingly, the base frame 1104 includes a coupler near a front 1105 of the trailer 1100 for coupling the trailer 1100 to the vehicle. In the subject embodiment, the coupler is a hitch receiver 1102. In other embodiments, the coupler may be a fifth wheel coupling, or other suitable coupler as is known in the art.

The hitch receiver 1102 is configured to receive a hitch (not shown) of the vehicle, as is known in the art, to couple the trailer 1100 to the vehicle. When the trailer 1100 is coupled to the vehicle, towing forces can be transferred from the vehicle to the trailer 1100 (or vise versa) via the hitch and the hitch receiver 1102. Such towing forces can then be transferred through the trailer 1100 by the base frame 1104, such as from the hitch receiver 1102 to the wheels 1110 (or vice versa).

The jack 1202 may be present near the front 1105 of the trailer 1100. The jack 1202 is configured to hold the trailer 1100 level, when the trailer 1100 is not coupled to a vehicle. When the trailer 1100 is not coupled to the vehicle, the jack 1202 rests on the ground and supports the front 1105 of the trailer 1100. The jack 1202 may be adjustable in height to help hold the trailer 1100 level.

The upper frame 1112 may be coupled to and supported by the base frame 1104 of the trailer 1100. The upper frame 1112 comprises a plurality of upper frame members 1118 that are coupled together and to the base frame 1104 to provide structural strength to the trailer 1100. The upper frame members 1118 may include vertical ribs, horizontal ribs, or other suitable members, and may be joined by welding, fasteners, or the like. In other embodiments, the upper frame members 1118 may comprise other suitable elements that are coupled together, such as hollow structural sections (HSS), composite panels, metal plates, or the like. The upper frame 1112 may include one or more panels to enclose at least a portion of the trailer 1100, such as the metal or canvas panels described above. As will be appreciated, in some embodiments the upper frame 1112 may be omitted entirely, such as where the trailer 1100 is a flat deck trailer or a flatbed trailer.

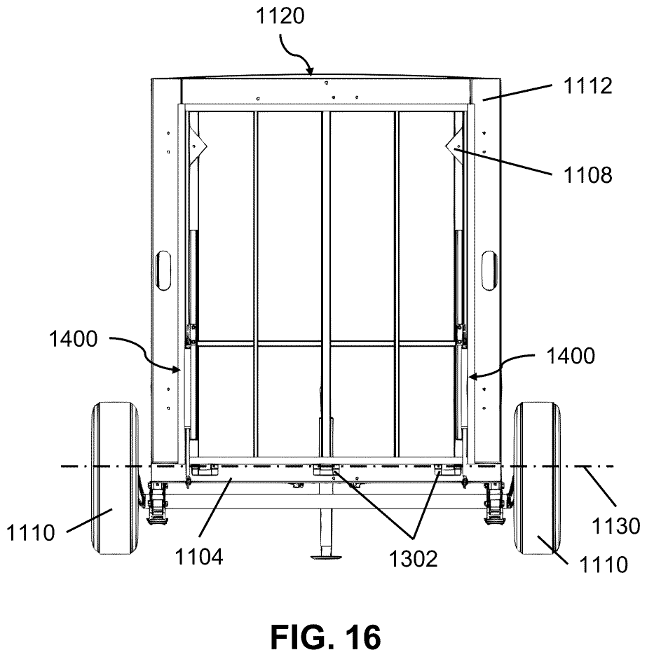

The ramp door assembly 1120 is located at a rear 1106 of the trailer 1100. The ramp door assembly 1120 is coupled to the base frame 1104, at the rear 1106 of the trailer 1100. As shown in FIG. 16, the ramp door assembly includes a ramp door 1108, a plurality of hinges 1302, and the pair of lift assist systems 1400. The ramp door assembly 1120 further includes a door mount 1412 and a base mount 1414 for each of the lift assist systems 1400. Accordingly, in the subject embodiment, the ramp door assembly 1120 includes two door mounts 1412 and two base mounts 1414.

The ramp door 1108 is pivotably coupled to base frame 1104. In the subject embodiments, the ramp door 1108 is pivotably coupled to the base frame 1104 via the plurality of hinges 1302. However, in other embodiments, the ramp door 1108 may be directly pivotably coupled to the base frame 1104. For example, the ramp door 1108 and/or the base frame 1104 may include hinges that are integrally formed therewith.

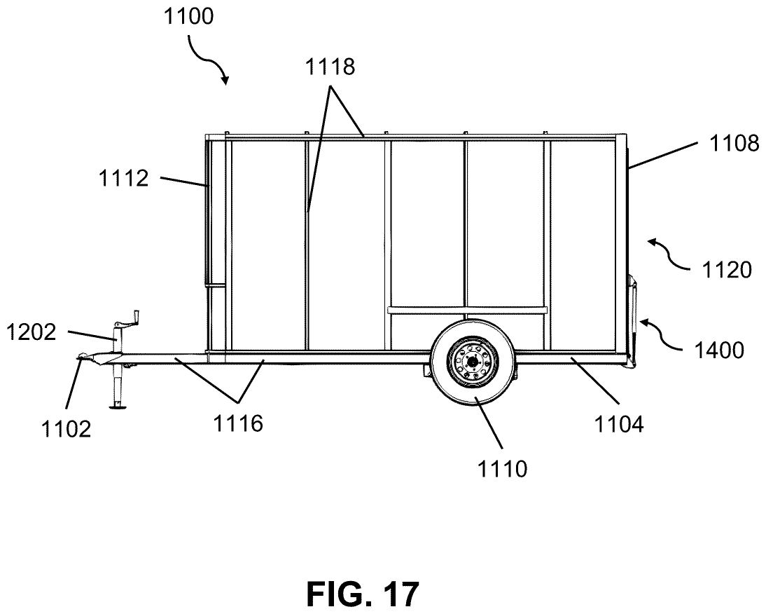

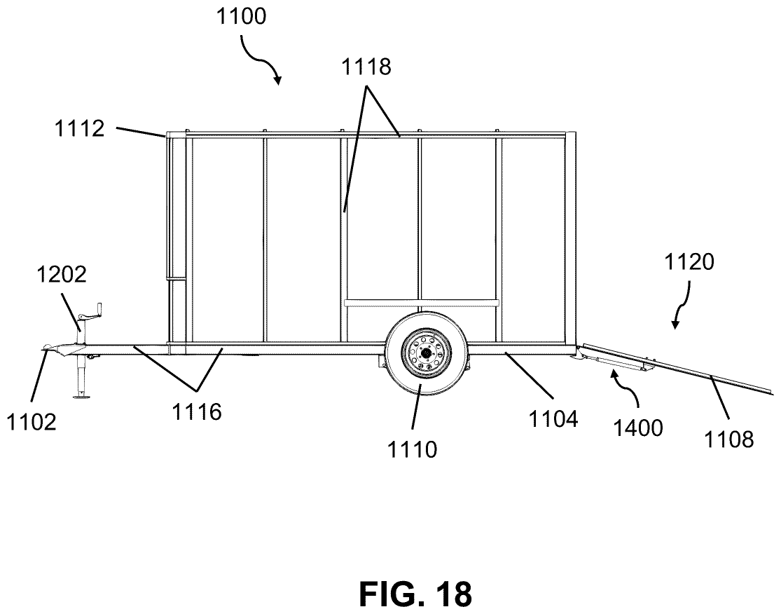

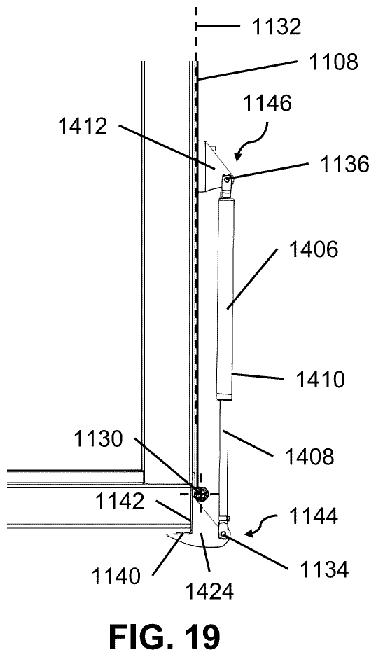

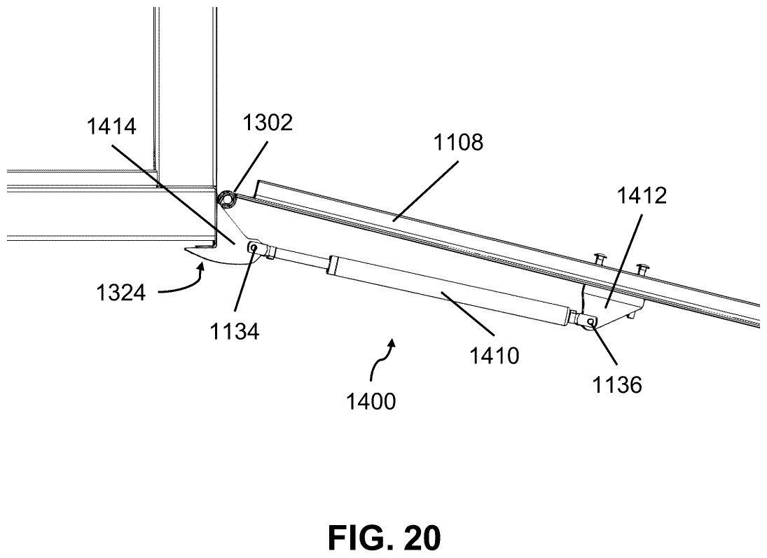

The ramp door 1108 is pivotable about a door axis 1130. In the subject embodiment, the door axis 1130 is defined by the hinges 1302. The ramp door 1108 is pivotable between a closed position (FIGS. 17 and 19) and an open position (FIGS. 18 and 20). As shown in FIG. 19, the ramp door 1108 defines a door plane 1132 in the closed position. The door plane 1132 is a generally vertical plane. In some embodiments, the door plane 1132 may be slightly tilted from vertical, such that a weight of the ramp door 1108 in the closed position will tend to hold the ramp door 1108 closed.

As discussed above, the ramp door assembly 1120 includes a pair of lift assist systems 1400. One of the lift assist systems 1400 is located near a right side of the ramp door 1108, and the other of the lift assist systems 1400 is located near a left side of the ramp door 1108. The lift assists systems 1400 are substantially the same. For example, the lift assist systems 1400 may be identical, or mirror images of each other. Accordingly, only one of the lift assist systems 1400 is described below for brevity.

The lift assist system 1400 is pivotably coupled to and extends between the base frame 1104 and the ramp door 1108. As shown in FIGS. 19 and 20, the lift assist system 1400 is pivotably coupled to the base frame 1104 at a base mounting point 1134, and the lift assist system 1400 is pivotably coupled to the ramp door 1108 at a door mounting point 1136. In the subject embodiment, a base end 1144 of the lift assist system 1400 is pivotably coupled to the base frame 1104 via the base mount 1414, and a door end 1146 of the lift assist system 1400 is pivotably coupled to the ramp door 1108 via the door mount 1412. However, in other embodiments, the lift assist system 1400 may be directly pivotably coupled to the base frame 1104 and/or the ramp door 1108. In such embodiments, the base frame 1104 and/or the ramp door 1108 may include integrally formed mounts for pivotably coupling to the lift assist system 1400.

The door mount 1412 comprises a generally L-shaped plate that is fixedly coupled to the ramp door 1108 at a proximal end, and is pivotably coupled to the lift assist system 1400 at a distal end. The base mount 1414 comprises a generally fin-shaped body 1424. The body 1424 is fixedly coupled at a proximal end 1324 to at least two non-parallel surfaces of the base frame 1104, and is pivotably coupled to the lift assist system 1400 at a distal end of the body 1424. In the subject embodiment, the proximal end 1324 of the base mount 1414 is fixedly coupled to an undersurface 1140 and to an outer surface 1142 of the base frame 1104. The proximal end 1324 of the base mount 1414 is laser cut to precisely match the shape of the base frame 1104 (e.g. to precisely match the at least two non-parallel surfaces). The mounts 1412, 1414 can be fixedly coupled by fasteners, welding, or the like. The mounts 1412, 1414 can be pivotably coupled to the lift assist system 1400 by clevis joints, or the like.

The lift assist system 1400 biases the ramp door 1108 towards the closed position. The lift assist system 1400 comprises a spring to bias the ramp door towards the closed position. In the subject embodiment, the spring is a pneumatic cylinder 1410 that acts as a gas spring. The pneumatic cylinder 1410 includes a piston rod 1408 and a barrel 1406. The piston rod 1408 travels within the barrel 1406 as the pneumatic cylinder 1410 is extended and compressed. As will be appreciated, an outward force generated by the pneumatic cylinder 1410 increases as the pneumatic cylinder 1410 is compressed. As shown in FIG. 19, the pneumatic cylinder 1410 is fully extended when the ramp door 1108 is in the closed position. Accordingly, the outward force generated by the pneumatic cylinder 1410 is at or near zero when the ramp door 1108 is in the closed position, which can allow the pneumatic cylinder 1410 to be easily installed when the ramp door 1108 is closed. As shown in FIG. 20, the pneumatic cylinder 1410 is fully compressed when the ramp door 1108 is in the open position. Thus, the outward force generated by the pneumatic cylinder 1410 increases as the ramp door 1108 is opened. The pneumatic cylinder 1410 also provides friction damping that may allow the ramp door 1108 to come down slowly and predictably, even when let go completely.

The operation of the ramp door assembly 1120 and the lift assist systems 1400 is the same as the operation of the ramp door assembly 620 and the lift assist systems 900 described above. Accordingly, the operation is not repeated herein, for brevity. Likewise, the locations of the base mounting point 1134 and the door mounting point 1136 are the same as the base mounting point 634 and the door mounting point 636 described above, and are not repeated herein, for brevity.

Although the aspects herein demonstrate the ramp door 108 at a rear of the trailer 100 opposite the hitch receiver 102, other aspects may have the ramp door 108 along a side of the trailer 100. Although the aspects herein demonstrate a trailer 100, the aspects herein may equally apply to any ramp door 108. Although the aspects herein demonstrate a single lift assist system or a pair of lift assist systems, other aspects may have more than two lift assist systems.

Although each ramp door assembly 120, 620, 1120 is shown and described herein as being coupled to a base frame of a trailer, it will be appreciated that in other aspects the ramp door assembly may be coupled to another type of base. For example, in an aspect where the ramp door assembly is used at a loading dock, the ramp door assembly may be coupled to a stationary base, such as a building or a concrete pad from which goods are loaded to and unloaded from trucks.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description of Embodiments”. While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A ramp door assembly coupled to a base, the ramp door assembly comprising:
a ramp door pivotably coupled to the base about a door axis, the ramp door being pivotable between a closed position and an open position; and
a lift assist system pivotably coupled to and extending between the ramp door and the base, the lift assist system comprising a spring to generate an assistive torque that biases the ramp door towards the closed position.

2. The ramp door assembly of claim 1, wherein the lift assist system is pivotably coupled to the ramp door at a door mounting point and is pivotably coupled to the base at a base mounting point.

3. The ramp door assembly of claim 2, wherein a vertical plane is defined through the door axis, wherein an undersurface of the base defines a horizontal plane, and wherein the base mounting point is vertically located at or below the horizontal plane and is horizontally located apart from the vertical plane in a direction that the ramp door opens.

4. The ramp door of assembly claim 2, wherein the base mounting point and the door mounting point are located, and the lift assist system is sized, such that the assistive torque generated by the lift assist system keeps the apparent weight of the ramp door at a lifting point from exceeding a maximum of 50 lbs as the ramp door pivots from the open position to the closed position.

5. The ramp door assembly of claim 4, wherein the ramp door assembly comprises a plurality of the lift assist systems, and wherein the assistive torque is a sum of the assistive torques generated by the plurality of the lift assist systems.

6. The ramp door assembly of claim 1, further comprising a door mount and a base mount, wherein the lift assist system is pivotably coupled to the ramp door via the door mount, and wherein the lift assist system is pivotably coupled to the base via the base mount.

7. The ramp door assembly of claim 6, wherein the base mount is fixedly coupled to at least two non-parallel surfaces of the base.

8. The ramp door assembly of claim 6, wherein the base mount comprises a pair of flanges and a base portion that define a U-shape, and wherein an end of the lift assist system is pivotably coupled to and received between the pair of flanges.

9. The ramp door assembly of claim 1, further comprising one or more hinges pivotably coupling the ramp door to the base.

10. The ramp door assembly of claim 1, wherein the spring is a pneumatic cylinder that acts as a gas spring to generate the assistive torque.

11. A trailer comprising:
a base frame for coupling to a vehicle;
a plurality of wheels pivotably coupled to the base frame, the wheels engaging a ground surface to support the base frame; and
a ramp door assembly coupled to the base frame, the ramp door assembly comprising:
a ramp door pivotably coupled to the base frame about a door axis, the ramp door being pivotable between a closed position and an open position; and
a lift assist system pivotably coupled to and extending between the ramp door and the base frame, the lift assist system comprising a spring to generate an assistive torque that biases the ramp door towards the closed position.

12. The trailer of claim 11, wherein the lift assist system is pivotably coupled to the ramp door at a door mounting point and is pivotably coupled to the base frame at a base mounting point.

13. The trailer of claim 12, wherein a vertical plane is defined through the door axis, wherein an undersurface of the base frame defines a horizontal plane, and wherein the base mounting point is vertically located at or below the horizontal plane and is horizontally located apart from the vertical plane in a direction that the ramp door opens.

14. The trailer of claim 12, wherein the base mounting point and the door mounting point are located, and the lift assist system is sized, such that the assistive torque generated by the lift assist system keeps the apparent weight of the ramp door at a lifting point from exceeding a maximum of 50 lbs as the ramp door pivots from the open position to the closed position.

15. The trailer of claim 14, wherein the ramp door assembly comprises a plurality of the lift assist systems, and wherein the assistive torque is a sum of the assistive torques generated by the plurality of the lift assist systems.

16. The trailer of claim 11, wherein the ramp door assembly further comprising a door mount and a base mount, wherein the lift assist system is pivotably coupled to the ramp door via the door mount, and wherein the lift assist system is pivotably coupled to the base frame via the base mount.

17. The trailer of claim 16, wherein the base mount is fixedly coupled to at least two non-parallel surfaces of the base.

18. The trailer of claim 16, wherein the base mount comprises a pair of flanges and a base portion that define a U-shape, and wherein an end of the lift assist system is pivotably coupled to and received between the pair of flanges.

19. The trailer of claim 11, wherein the ramp door assembly further comprises one or more hinges pivotably coupling the ramp door to the base frame.

20. The trailer of claim 11, wherein the spring is a pneumatic cylinder that acts as a gas spring to generate the assistive torque.
